(19) United States
(12) Patent Application Publication
(10) Pub. No.: US 2025/0378178 A1
(43) Pub. Date: Dec. 11, 2025

(54) System and Method for Adaptive, Closed-Loop Prioritization of Cybersecurity Controls

(71) Applicant: Jeffrey Pettingill, Mitchell, IN (US)

(72) Inventor: Jeffrey Pettingill, Mitchell, IN (US)

(21) Appl. No.: 19/275,960

(22) Filed: Jul. 21, 2025

(51) Int. Cl. G06F 21/57; G06F 16/38

(52) U.S. Cl. CPC G06F 21/577; G06F 16/38; G06F 2221/2101

(57) ABSTRACT

A computer-implemented system and method for dynamic, explainable, and adaptive prioritization of cybersecurity controls is disclosed. The system ingests unstructured threat reports and employs a natural language processing (NLP) module to automatically extract adversary tactics, techniques, and procedures (TTPs). A scoring module applies a mathematical time-decay function to the extracted intelligence. A novel hybrid prioritization engine provides explainability-by-design by computationally integrating these objective, data-driven scores with organization-specific context within a transparent multi-criteria decision analysis (MCDA) model. Critically, the system establishes a self-optimizing closed feedback loop; it receives real-world control effectiveness metrics from the operational environment and uses this data as new ground-truth labels to continuously and automatically retrain internal machine learning models. This adaptive mechanism improves the computer's own predictive accuracy and resource allocation efficiency over time, representing a tangible technical improvement.

### CROSS-REFERENCE TO RELATED APPLICATIONS

This application claims the benefit of U.S. Provisional Patent Application No. 63/831,098, filed on Jun. 26, 2025, the entirety of which is incorporated by reference herein.

### BACKGROUND OF THE INVENTION

### Field of the Invention

The present invention pertains generally to the field of computer-implemented cybersecurity. More specifically, it relates to systems and methods for the automated, dynamic, and data-driven prioritization of cybersecurity controls to improve the efficiency and accuracy of a computer system's resource allocation for cyber defense.

### Description of the Related Art

The management of cybersecurity risk in modern enterprise environments presents a series of profound technical challenges for which conventional computer systems and methodologies are ill-equipped. These challenges stem from the overwhelming volume, velocity, and variety of data that must be processed to make effective defensive decisions. The prior art in this field is characterized by fragmented, often manual, and static approaches that fail to provide a cohesive, automated, and adaptive solution.

Furthermore, while some modern security operations platforms, such as those used for enterprise-wide security monitoring, may employ ‘closed-loop’ processes and machine learning, these loops are typically operational or managerial in nature. They focus on the lifecycle of a security incident ticket—from detection and automated response to closure and reporting. Such systems improve operational efficiency but lack the specific technical mechanism for creating a truly self-optimizing and adaptive control system. Specifically, they do not computationally measure the real-world effectiveness of an implemented control and then automatically use that quantitative metric as a new ground-truth training label to retrain and improve the underlying predictive models of the system itself. This leaves a critical gap, as the system does not learn from the outcomes of its own recommendations to improve its future intelligence.

While authoritative guidelines such as NIST Special Publication 800-82r3 provide a comprehensive framework for managing operational technology security, they are fundamentally prescriptive guides for human-led governance and implementation. They define the ‘what’ of a robust security program but do not provide the ‘how’ in the form of an automated, integrated system. The present invention provides the specific, computer-implemented technical means to automate the principles of such frameworks, enabling the continuous, data-driven prioritization and adaptation of security controls at a scale and velocity that is unachievable through the manual, process-based approaches described in the prior art.

A first critical technical problem is that of data overload and alert fatigue, a condition aptly described as the “fog of more.” Security Operations Centers (SOCs) are inundated with data from a multitude of disparate security tools, with a typical organization facing over 10,000 security alerts per day. This leads to a well-documented phenomenon known as alert fatigue, wherein human security analysts become desensitized to the constant stream of warnings, causing critical threats to be missed within the noise. This problem is worsening; a 2025 report from the World Economic Forum found that 71% of cyber leaders believe small organizations can no longer adequately secure themselves against the growing complexity of cyber risks. While the number of internet crime complaints filed with the FBI's Internet Crime Complaint Center (IC3) saw a slight decrease in 2024 to 859,532, the associated financial impact surged, with reported losses exceeding $16 billion—a 33% increase from 2023.

This demonstrates that cyberattacks are becoming more targeted and financially devastating, making effective prioritization more critical than ever.

This data deluge is compounded by the sheer volume of newly discovered software vulnerabilities. In 2024, a record number of new Common Vulnerabilities and Exposures (CVEs) were published, and projections for 2025 suggest this number will likely exceed 50,000. For any organization, the manual analysis and remediation of every potential threat and vulnerability is computationally and operationally infeasible. This creates a specific technical problem: conventional computer systems lack the means to efficiently and accurately distinguish high-priority threats from low-priority noise at machine scale, leading to wasted computational resources, inefficient allocation of human capital, and dangerously delayed response times to actual attacks. This problem is exacerbated by a new technical barrier: the “trust latency” in public vulnerability data. In 2024, the U.S. National Vulnerability Database (NVD), the primary public body for vulnerability analysis, failed to analyze approximately half of the vulnerabilities published that year. This creates a critical information vacuum, meaning that even automated systems relying on NVD data are operating with incomplete and delayed intelligence. A system that can generate its own intelligence by processing primary-source, unstructured threat reports provides a specific technical solution to this failing public infrastructure.

A second technical problem is the challenge of processing unstructured threat intelligence, particularly in the context of modern, identity-centric attack vectors. A vast and valuable repository of timely, actionable threat intelligence is locked within unstructured, human-language text, which is estimated to comprise approximately 80% of all global data. Computer systems, by their nature, cannot directly process or reason over this unstructured data. The 2025 Verizon Data Breach Investigations Report (DBIR) underscores the urgency of solving this problem, finding that the “human element” remains a factor in approximately 60% of breaches, while stolen credentials were the primary initial access vector in 22% of breaches. Furthermore, breaches involving a third party doubled to 30%. These trends are not independent; a common attack chain involves an employee at a third-party vendor (the human element) being phished for their credentials, which are then used to attack the primary organization. A computer system that only analyzes structured, internal data will miss the unstructured threat report about a breach at a key supplier, failing to connect these dots. This forms a major technical barrier to achieving a truly comprehensive defense, creating a need for a machine implementation that can automate the transformation of unstructured text into structured, computationally useful data.

A third technical problem is the static nature of conventional risk analysis and the temporal decay of threat intelligence. Most existing risk frameworks are static, point-in-time evaluations that quickly become historical documents. The value and relevance of threat intelligence has a finite shelf life; it decays over time. A computer system that assigns the same computational weight to a threat indicator from last week as one from last year is inherently flawed and produces inaccurate risk assessments. These technical challenges are directly linked to severe financial consequences. According to the IBM Cost of a Data Breach Report 2024, the global average cost of a data breach reached a new record high of USD 4.88 million, a 10% increase from the previous year. For specific, highly-regulated sectors, the costs are even more severe: the average breach cost for the financial industry was USD 6.08 million, and for the industrial sector, it was USD 5.56 million. Conversely, the same report found that organizations extensively using AI and automation saved an average of USD 1.9 million to USD 2.2 million per breach, providing a powerful, data-backed rationale for an automated approach.

Finally, the prior art consists of a collection of fragmented and incomplete frameworks, each addressing only a single facet of the prioritization problem. This fragmentation itself constitutes a technical problem, as no single existing framework effectively and automatically integrates the necessary components for a holistic solution. The following table provides an expanded comparative analysis of dominant prior art categories and the present invention, demonstrating the unique and non-obvious combination of features in the proposed system.

| | Unstructured | | | | | |
|---|---|---|---|---|---|---|
| Framework/ | Data | Temporal | Prioritization | Explainability/ | Adaptiveness/ | Integration |
| System | Processing | Analysis | Logic | Auditability | Learning | Level |
| NIST CSF/ | Manual/ | Static | Qualitative/ | Low | None | Siloed |
| ISO 27001 | N/A | (Point-in- | Consensus | (Process- | (Manual | (Governance) |
| | | Time) | | based) | Updates) | |
| CVSS | N/A | Static (At | Quantitative | Medium | None | Siloed |
| | | Disclosure | (Technical | (Formulaic) | | (Vulnerability) |
| | | | Severity | | | |
| | | | Only) | | | |
| FAIR/ | Manual | Static | Quantitative | Medium | None | Siloed |
| QRA | Input | (Often | (Financial) | (Model- | (Manual | (Financial |
| Models | | Manual) | | dependent) | Updates) | Risk) |
| Basic | Manual | Static | Qualitative/ | Low | None | Siloed |
| ATT&CK | | (Historical) | Manual | (Subjective) | | (Threat |
| Mapping | | | | | | Intel) |
| U.S. Pat. No. | N/A | Static | Quantitative | Low | Partial | Partial |
| 9,032,521 | | | Scoring | (“Black Box” | (Score update | |
| B2 | | | | Score) | only) | |
| OpenCTI | N/A | Automated | Score- | High | None | Siloed |
| w/Decay | | Decay | based | (Rule-based) | (Score decay | (Indicator |
| | | | (Indicator) | | only) | Mgmt) |
| Academic | Automated | Static | N/A | N/A | None | Siloed |
| TTP | NLP | (Timestamp | (Extraction | | | (Data |
| Extractors | | only) | only) | | | Extraction) |
| (e.g., | | | | | | |
| TTPXHunter) | | | | | | |
| The | Automated | Automated | Hybrid | High | High | Fully |
| Present | NLP-to- | Decay | ML-MCDA | (Transparent & | (Closed- | Integrated |
| Invention | Structured | Function | | Auditable | Loop ML | End-to- |
| | (SKR) | | | MCDA) | Retraining) | End |

As shown, existing approaches rely on a human-scalability bottleneck. A human analyst is required to bridge the gaps between these fragmented systems. This reliance on manual human cognition and labor is fundamentally unscalable in the face of exponential growth in data volume and threat velocity. Therefore, what is needed is not merely an incremental improvement to one of these silos, but a new category of integrated, computer-implemented system that automates the cognitive-heavy lifting that humans currently perform, thereby solving the technical problems of data overload, static analysis, and fragmented decision-making.

### BRIEF SUMMARY OF THE INVENTION

The present invention is directed to a system and computer-implemented method for dynamic, explainable, and adaptive prioritization of cybersecurity controls that overcomes the deficiencies of the prior art. The system comprises a processor and a non-transitory computer-readable storage medium storing instructions that, when executed, cause the system to perform a series of specific, interconnected operations that provide a tangible technical improvement to the functioning of the computer itself.

In one aspect, the system provides a technical solution to the problem of unstructured data overload by employing a specialized Natural Language Processing (NLP) module.

This module is configured to automatically ingest a plurality of unstructured threat reports from disparate sources, process the text using a trained language model to extract adversary tactics, techniques, and procedures (TTPs), and map these TTPs to a structured, machine-readable data format. This represents a specific machine implementation that automates the transformation of unstructured human-language data into a computationally useful format, a task previously intractable for computer systems at scale.

In another aspect, the system provides a technical solution to the problem of static analysis and threat intelligence decay by implementing a scoring module. This module is configured to calculate a time-decayed threat score for each extracted TTP by applying a predefined mathematical decay function based on a timestamp associated with the source threat report. This specific computational step improves the computer's ability to process and weigh time-sensitive data, ensuring that the system's risk calculations are dynamically biased toward more recent, and therefore more relevant, threats.

In a further aspect, the system improves upon the opaque and subjective decision-making of prior art models by utilizing a novel hybrid prioritization engine. This engine is configured to computationally integrate objective, data-driven outputs, such as the time-decayed threat scores and machine-learning-predicted risk criteria, with organization-specific context, such as asset criticality data and user-defined weighting criteria, within a transparent Multi-Criteria Decision Analysis (MCDA) model. This hybrid architecture improves the computer's decision-making process, enabling it to efficiently and accurately allocate defensive resources in a manner that is both data-driven and auditable, providing an explainable basis for its recommendations.

In yet another aspect, the system provides a profound technical improvement over the prior art by establishing a self-optimizing, closed-loop control mechanism. This is distinct from conventional operational feedback loops. The system is configured to generate a machine-readable, prioritized list of security controls. A feedback module is communicatively coupled to the prioritization engine and is configured to receive control effectiveness metrics that quantify the real-world performance change resulting from a previously implemented control. This feedback data is then used as a new ground-truth label to automatically retrain and refine one or more machine learning models within the hybrid engine. This transforms the system from a static calculator into a self-optimizing control system that improves its own predictive accuracy and performance over time, a clear inventive concept rooted in computer technology.

### BRIEF DESCRIPTION OF THE SEVERAL VIEWS OF THE DRAWING

FIG. 1 is a high-level system architecture diagram illustrating the primary modules of the dynamic control prioritization system and the flow of data between them, in accordance with one embodiment of the invention.

FIG. 2 is a flowchart illustrating the process of the data ingestion and Natural Language Processing (NLP) module, in accordance with one embodiment of the invention.

FIG. 3 is a flowchart illustrating the process of the temporal decay scoring module, in accordance with one embodiment of the invention.

FIG. 4 is a block diagram illustrating the architecture of the hybrid Multi-Criteria Decision Analysis (MCDA) and Machine Learning (ML) prioritization engine, in accordance with one embodiment of the invention.

FIG. 5 is a diagram illustrating an exemplary hierarchical structure for the Analytic Hierarchy Process (AHP) used within the hybrid prioritization engine, in accordance with one embodiment of the invention.

FIG. 6 is a flowchart illustrating the process of the closed-loop feedback and model refinement system, in accordance with one embodiment of the invention.

FIG. 7 is a simplified block diagram illustrating the two-stage data flow within the hybrid prioritization engine, visually emphasizing the “explainable AI” concept, in accordance with one embodiment of the invention.

### DETAILED DESCRIPTION OF THE INVENTION

The following detailed description is of the best currently contemplated modes of carrying out the invention. The description is not to be taken in a limiting sense but is made merely for the purpose of illustrating the general principles of the invention, as the scope of the invention is best defined by the appended claims. Various inventive features are described below that can each be used independently of one another or in combination with other features.

The present invention provides a technical solution to the deficiencies of conventional cybersecurity risk management systems. Conventional systems are fundamentally inefficient, relying on static data, being incapable of automatically processing unstructured threat intelligence, and utilizing opaque or overly subjective models. This results in wasted computational resources, delayed responses to critical threats, and an inability to provide auditable justification for resource allocation. The present invention overcomes these problems by implementing a dynamic, closed-loop control prioritization system that enhances the functioning of the computer itself.

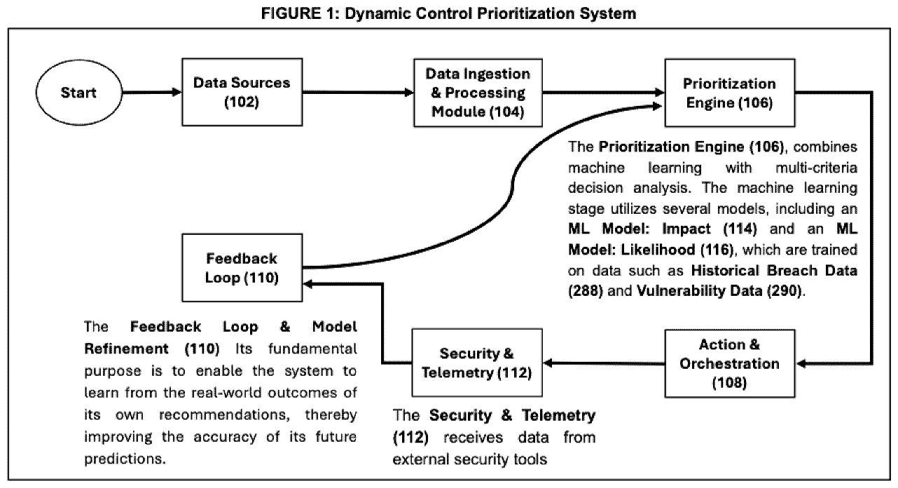

### System Architecture and Operating Environment (FIG. 1)

Referring to FIG. 1, a high-level system architecture diagram of an exemplary embodiment of the dynamic control prioritization system is shown. The system may be implemented on one or more server computers, which may be located in a cloud computing environment such as Amazon Web Services (AWS) or Microsoft Azure, or on-premise within an organization's data center. Each server comprises at least one processor and non-transitory computer-readable storage media (e.g., RAM, hard disk drives). The system comprises a plurality of interconnected software modules, which may communicate via application programming interfaces (APIs), such as REST APIs, or message queues (e.g., RabbitMQ, Apache Kafka), configured to execute the operations of the invention.

The system ingests data from a variety of Data Sources. These include unstructured Cyber Threat Intelligence (CTI) reports, structured threat intelligence feeds (e.g., STIX/TAXII feeds), and internal data sources such as a Configuration Management Database (CMDB) which contains asset information and criticality ratings. A Data Ingestion & Processing Module receives this data. As will be described in further detail, this module includes a Natural Language Processing (NLP) component for extracting TTPs from unstructured text and a temporal scoring component for applying a time-decay function to all threat intelligence. The processed and scored data is then fed into a Prioritization Engine. This engine, in a preferred embodiment, is a hybrid MCDA-ML engine that computes a quantitative risk score and generates a prioritized list of security controls.

The hybrid MCDA-ML architecture of the prioritization engine provides a significant technical advantage over conventional AI systems by achieving ‘explainability-by-design,’ a concept fundamentally different from post-hoc explanation techniques common in the field of Explainable AI (XAI). Whereas XAI methods such as LIME or SHAP attempt to approximate the reasoning of an already-trained, opaque ‘black-box’ model, the present invention's engine is architected for inherent transparency. By decomposing the prioritization task, it leverages machine learning for objective factor prediction and employs a formal, mathematically transparent MCDA framework like AHP to integrate these predictions with user-defined business context. The final prioritization is the result of an explicit, auditable calculation based on defined criteria and weights, thus solving the ‘black-box’ problem at an architectural level rather than attempting to interpret it after the fact.

The NLP module of the present invention is functionally and architecturally distinct from prior art systems that translate natural language user queries into database queries. Such systems are primarily human-computer interface enhancements, designed to reactively process a single user's question. In contrast, the present invention's NLP module operates as a proactive and autonomous intelligence generation engine. It is configured to continuously ingest and process a plurality of external, unstructured threat reports from disparate sources, performing the complex cognitive task of extracting abstract adversary tactics, techniques, and procedures (TTPs) and mapping them to a standardized, structured format. This automated transformation of raw, external human-language text into a machine-readable knowledge base for direct use in subsequent automated analysis represents a fundamental departure from mere query translation systems.

The prioritized list is transmitted for Action & Orchestration, for example, to a Security Orchestration, Automation, and Response (SOAR) platform, a ticketing system (e.g., ServiceNow, Jira), or for manual remediation by a security team. The system then monitors the operational environment via Security Telemetry & Monitoring tools. These tools, which may include Security Information and Event Management (SIEM) systems, Endpoint Detection and Response (EDR) platforms, and firewalls, provide data on the effectiveness of the implemented controls.

This effectiveness data, referred to as control metrics, is passed to a Feedback Loop & Model Refinement module. This module uses the real-world outcome data to retrain and improve the machine learning models within the Prioritization Engine, thus closing the loop and creating an adaptive, self-improving system. This complete, cyclical data flow represents a significant improvement over open-loop, static analysis systems.

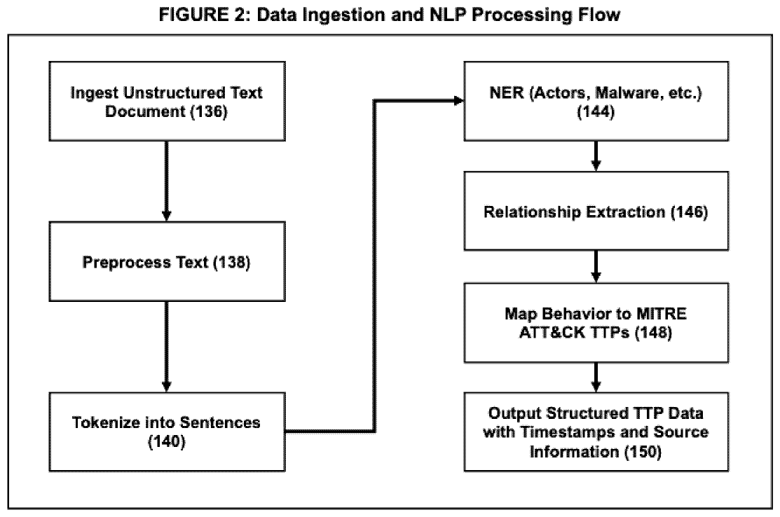

### Unstructured Data Ingestion and NLP Module (FIG. 2, Algorithm 1)

Referring to FIG. 2 and Algorithm 1, the process for transforming unstructured text into structured, actionable intelligence is detailed. This module provides a specific machine implementation that solves the technical problem of computers being unable to process human-language threat reports at scale.

In a preferred embodiment, the NLP pipeline is built around a transformer-based Large Language Model (LLM), such as a domain-specific variant like SecureBERT, that has been fine-tuned on a specialized corpus of cybersecurity-related text. This fine-tuning on a relevant corpus represents a deeper technical contribution than using a generic model. The feasibility of this approach is supported by recent academic research; for example, the TTPXHunter methodology has achieved F1-scores as high as 97.09% on report datasets for TTP extraction, providing concrete evidence that such a module is not speculative.

A key inventive step of this module is the use of a novel knowledge structure, hereinafter referred to as a “Situational Knowledge Representation” (SKR), which is inspired by recent advancements in standard-driven TTP extraction. This SKR provides a direct technical solution to the “standard adherence” problem, where many NLP models focus on fitting a dataset rather than strictly adhering to the official MITRE ATT&CK standard, leading to inconsistent outputs. The SKR is a dual-layer structure: Layer 1 identifies the broad situational context (e.g., “Communication with C2 using encoded subdomains”), while Layer 2 captures the specific, distinctive features that differentiate similar techniques (e.g., distinguishing T1132 “Data Encoding” from T1071 “Application Layer Protocol”). By using an SKR, the NLP module performs a more consistent, transparent, and standard-adherent extraction, which is a non-obvious improvement over the prior art. As outlined in Algorithm 1, the NLP pipeline performs a series of information extraction tasks. After preprocessing the text, it applies Named Entity Recognition (NER) to identify key entities. It then applies Relationship Extraction to understand the actions connecting these entities. A critical step is TTP Mapping, where the system maps the described adversary behaviors to the standardized lexicon of the MITRE ATT&CK framework. For example, a sentence like “The attacker gained initial access via a spearphishing email containing a malicious macro” would be computationally mapped to ATT&CK Techniques T1566.001 (Phishing: Spearphishing Attachment) and T1059.005 (Command and Scripting Interpreter: Visual Basic). The output is a set of structured, machine-readable data objects, each containing the TTP ID, the timestamp from the source document, a confidence score, and associated entities. This explicitly details the transformation of unstructured human language into a computationally useful format, a key technical achievement.

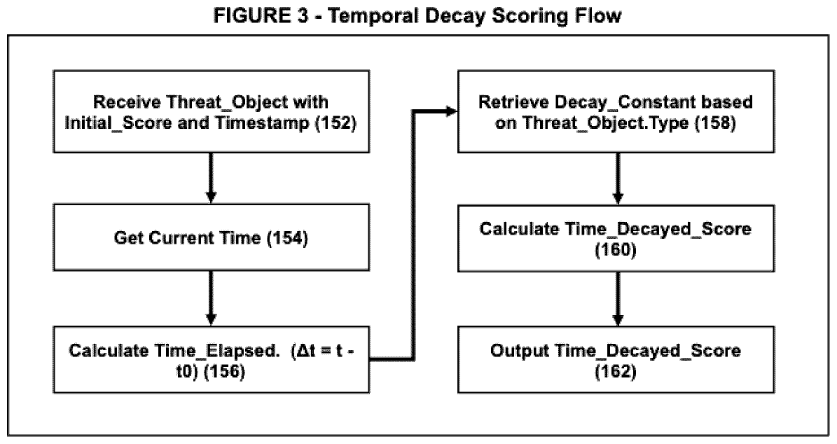

### Temporal Decay Scoring Module (FIG. 3, Algorithm 2)

Referring to FIG. 3 and Algorithm 2, the process for computationally modeling threat intelligence decay is detailed. This module provides a specific technical improvement to a computer's ability to process and weigh time-sensitive data, solving the problem of static risk posture.

The core of this module is the application of a mathematical decay function to calculate a current threat score. In a preferred embodiment, this is an exponential decay model, as shown in the formula: S(t)=S0e−λΔt. Here, S(t) is the time-decayed score at the current time t, S0 is the initial threat score, Δt is the elapsed time since the intelligence was published, and λ is the decay constant. This calculated score is a critical, dynamically weighted input into the subsequent hybrid prioritization engine.

In a further preferred embodiment, the decay constant λ is not a single, fixed value. Instead, it is a computationally determined parameter that varies based on the type of threat indicator. For example, a highly volatile indicator like a command-and-control (C2) IP address, which may change in hours, would be assigned a high λ value (e.g., 0.05, corresponding to a half-life of approximately two weeks), causing its score to decay rapidly. In contrast, a more persistent adversary TTP, representing a fundamental behavior that may remain relevant for years, would be assigned a much lower λ value (e.g., 0.001, corresponding to a half-life of approximately two years). This specific computational treatment improves the accuracy and efficiency of the computer's risk calculations. While the exponential decay function is a preferred embodiment, in alternative embodiments, other mathematical models could be employed, such as a power-law decay function, S(t)=S0 (1+τΔt)−α, which may be suitable for modeling phenomena where initial decay is rapid but long-term relevance persists more strongly. The key inventive concept is the application of a computational decay model to create a dynamic, time-aware risk assessment system.

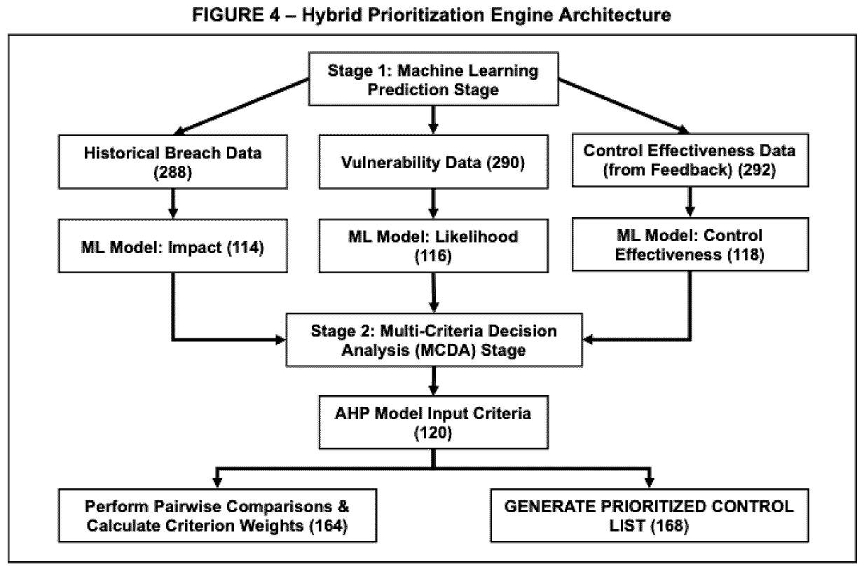

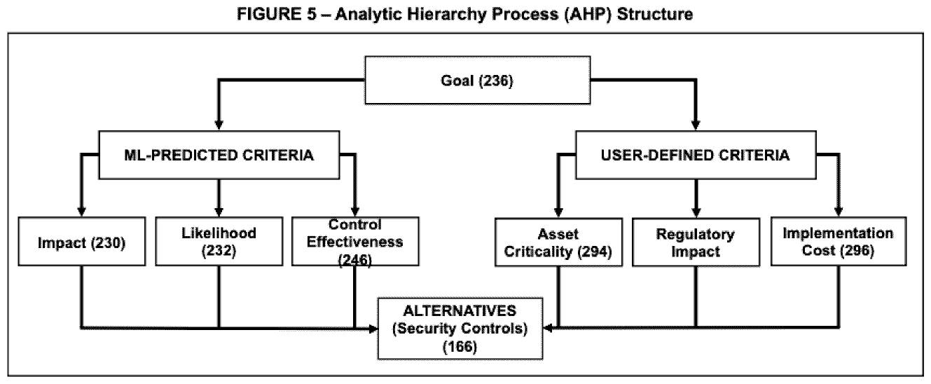

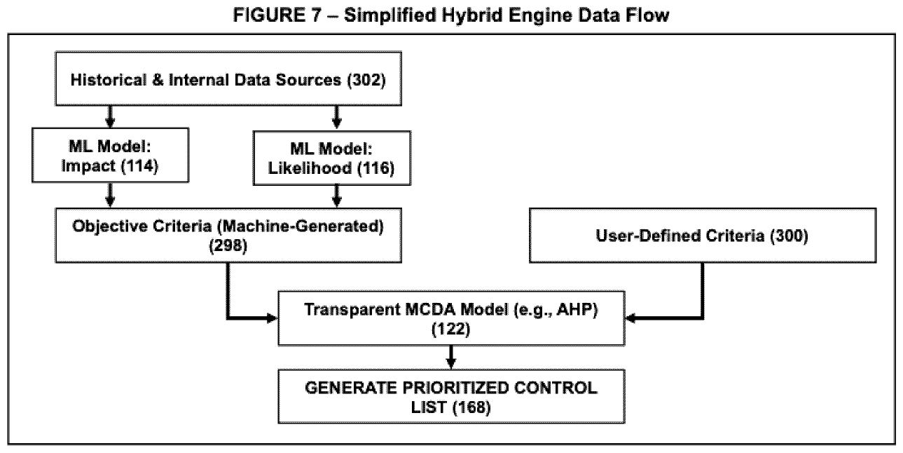

### Hybrid MCDA-ML Prioritization Engine (FIG. 4, FIG. 5, FIG. 7, Algorithm 3)

Referring to FIG. 4, FIG. 5, FIG. 7, and Algorithm 3, the architecture and operation of the novel hybrid prioritization engine are detailed. This engine represents a core inventive concept, providing a non-obvious synthesis of Machine Learning (ML) and Multi-Criteria Decision Analysis (MCDA) to solve the technical problems of opaque, “black-box” AI and overly subjective manual prioritization models. The engine is explicitly framed as a tangible technical solution to the “black box” problem, a significant concern in AI adoption where opaque models are difficult to trust, audit, or prove compliant with regulations. The engine operates in a two-stage process, as illustrated in FIG. 7.

Stage 1: Machine Learning for Factor Prediction. In this stage, the system utilizes a suite of supervised ML models (e.g., Gradient Boosting, Neural Networks) trained on historical data. The purpose of these ML models is not to make the final prioritization decision, but rather to serve as a sophisticated feature engineering engine that predicts key objective factors that will serve as criteria for the MCDA model. Predicted criteria may include: Likelihood of Exploitation, Predicted Impact Magnitude, and a Control Effectiveness Score.

For example, the ML model for predicting ‘Likelihood of Exploitation’ may be trained on a corpus of historical security data comprising structured vulnerability information from public feeds (e.g., NVD, CVE), records of past security incidents from an organization's SIEM, threat intelligence reports detailing active exploitation campaigns, and network telemetry data indicating scanning or reconnaissance activity against specific assets. This diverse dataset allows the model to learn complex patterns that correlate specific vulnerabilities with real-world exploitation attempts.

Stage 2: MCDA for Contextual Prioritization. The objective, ML-predicted scores from Stage 1 are then fed as inputs into a formal MCDA framework. In a preferred embodiment, this framework is the Analytic Hierarchy Process (AHP), chosen for its mathematical rigor and inherent transparency. As illustrated in FIG. 5, the AHP model is structured hierarchically with a Goal, Criteria, and Alternatives. The Criteria layer is a hybrid, combining the objective, ML-predicted scores with organization-specific, subjective criteria (e.g., Asset Criticality, Regulatory Compliance Impact) set by human experts via pairwise comparisons. As detailed in Algorithm 3, the final score for each control is calculated as a weighted sum, resulting in a mathematically derived, ranked list. In an alternative embodiment, the MCDA framework could be the Technique for Order of Preference by Similarity to Ideal Solution (TOPSIS).

The inventive step lies in the synthesis of these two distinct technical fields to create a system with a property that neither can achieve alone in this context: scalable, data-driven, and fully explainable prioritization. Pure ML models are powerful but often opaque “black boxes,” creating trust and audit Issues. Pure MCDA models are transparent but rely on manual, subjective inputs, which are unscalable and prone to bias. The invention's hybrid engine uses ML to automate the generation of objective, data-driven inputs, solving the MCDA scalability problem. It then uses MODA to provide a transparent, “white-box” framework for combining those inputs with business context, solving the ML black-box problem. This synthesis creates a system with the novel emergent property of “explainable automation at scale,” a powerful argument for non-obviousness. An analyst or auditor can interrogate the system and understand precisely why a given control was prioritized by examining the explicit AHP criteria and their assigned weights, providing a traceable and defensible basis for decisions.

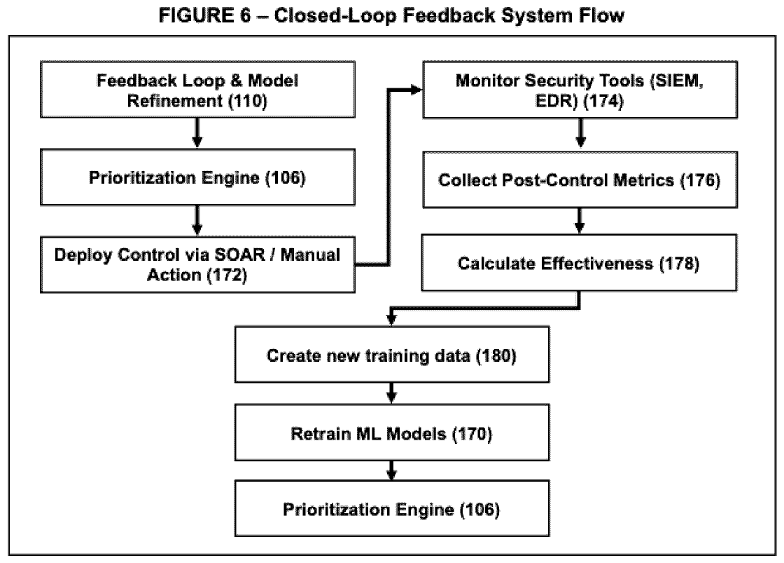

### Closed-Loop Feedback and Model Refinement Module (FIG. 6, Algorithm 4)

Referring to FIG. 6 and Algorithm 4, the adaptive, closed-loop nature of the system is detailed. This component transforms the invention from a static data processing tool into a dynamic, learning control system, which is a profound technical improvement over the prior art. Conventional Security Orchestration, Automation, and Response (SOAR) platforms execute predefined, static “playbooks” to automate repetitive tasks. While there is a trend toward integrating AI/ML for improved alert triage and threat detection, these systems largely remain “open-loop” from a control theory perspective. They execute a command (a playbook) but have no innate mechanism to learn if that command was effective in improving the security posture.

The present invention introduces a “closed-loop” system. The process begins with the output of the prioritization engine being transmitted to an actioning system, such as a SOAR platform. The system then ingests security telemetry to measure the real-world effectiveness of the implemented controls, tracking Key Performance Indicators (KPIs) such as Mean Time to Detect (MTTD), Mean Time to Respond (MTTR), or a reduction in successful phishing clicks.

As outlined in Algorithm 4, the measured outcomes become new ground-truth labels for the next cycle of ML model training. For instance, if a control was predicted to have high effectiveness but its implementation resulted in no measurable improvement in MTTD, this outcome data is used as a new training sample to refine the Control Effectiveness prediction model. This automated feedback loop allows the system to continuously learn from its own recommendations and improve its own performance over time. This reframes the invention not as a better SOAR platform, but as a different class of system—an adaptive cybersecurity control system. This conceptual leap elevates the system from simple automation to a form of self-optimizing autonomy, representing a significant and non-obvious inventive concept rooted in computer technology.

It is a critical aspect of the present invention that the closed-loop feedback mechanism provides a tangible technical improvement to the functioning of the computer system itself. By automatically using measured control effectiveness metrics as new ground-truth labels for retraining the internal machine learning models, the system engages in a self-optimizing process. This process directly enhances the computer's own predictive capabilities, leading to more accurate future prioritizations. Consequently, the system reduces computational waste that would otherwise be expended on analyzing and recommending ineffective controls, and it improves the overall efficiency and accuracy of the computer's resource allocation for cyber defense. This transforms the system from a static analytical tool into a dynamic control system that improves its own performance over time, a specific technical solution to the problem of static and inefficient cyber risk management.

The generation of a new ground-truth label from a control effectiveness metric is a key computational step. For example, if the system recommends a control involving enhanced email filtering to counter a specific phishing TTP (e.g., T1566.001), the feedback module would monitor security telemetry from the email gateway and endpoint protection tools. It may ingest data on the number of malicious emails quarantined and the number of successful phishing clicks by users over a defined period post-implementation. A metric could be calculated as the percentage reduction in successful clicks compared to a pre-implementation baseline. If the ML model had predicted an 80% effectiveness for this control, but the measured reduction was only 45%, the pair consisting of the control's features and the measured outcome of ‘45% effectiveness’ would be formatted as a new training sample. This sample is then used in the next automated retraining cycle of the ‘Control Effectiveness Score’ model, allowing the system to refine its predictions based on tangible, real-world results.

What is claimed is:

1. A system for dynamic and adaptive prioritization of cybersecurity controls, the system comprising:
a processor; and
a non-transitory computer-readable storage medium storing instructions that, when executed by the processor, cause the system to perform operations comprising:
(a) automatically processing, via a natural language processing (NLP) module, a plurality of unstructured threat reports to extract a structured threat object, the structured threat object comprising an adversary tactic, technique, or procedure (TTP) and an associated timestamp derived from a publication date of a corresponding unstructured threat report;
(b) computationally generating, via a scoring module, a time-decayed threat score for the extracted TTP by applying a mathematical decay function to an initial score based on an elapsed time calculated from the associated timestamp, wherein the time-decayed threat score represents a current relevance of the TTP;
(c) predicting, via one or more machine learning (ML) models trained on historical security data, at least one objective risk criterion associated with the TTP;
(d) generating, via a hybrid prioritization engine, a prioritized list of cybersecurity controls by computationally integrating the time-decayed threat score, the at least one predicted objective risk criterion, and a user-defined asset criticality value within a multi-criteria decision analysis (MCDA) model, wherein the MCDA model provides an explainable and auditable basis for the prioritization; and
(e) creating a self-optimizing closed-loop system by:
(i) receiving a control effectiveness metric from an operational environment, said metric computationally quantifying a measured performance change resulting from a previously implemented cybersecurity control from the prioritized list, and
(ii) automatically using said control effectiveness metric as a new ground-truth training label to retrain the one or more ML models of step (c), thereby causing the system to adaptively improve a predictive accuracy of its future prioritizations over time.

2. The system of claim 1, wherein the NLP module comprises a transformer-based large language model fine-tuned on a corpus of cybersecurity-related text.

3. The system of claim 1, wherein the structured threat object further comprises a mapping of the extracted TTP to the MITRE ATT&CK framework.

4. The system of claim 1, wherein the mathematical decay function is an exponential decay function defined by the formula S(t)=S0e−λΔt, where S(t) is the time-decayed threat score, S0 is the initial score, λ is a decay constant, and Δt is the elapsed time.

5. The system of claim 4, wherein the decay constant λ is computationally determined based on a type of the extracted TTP, wherein a higher decay constant is assigned to more volatile TTPs.

6. The system of claim 1, wherein the at least one objective risk criterion predicted by the one or more ML models is selected from the group consisting of a likelihood of exploitation, a predicted impact magnitude, and a predicted control effectiveness score.

7. The system of claim 1, wherein the MCDA model is an Analytic Hierarchy Process (AHP) model.

8. The system of claim 7, wherein the AHP model calculates a final priority score for each cybersecurity control based on a set of auditable, user-defined weighting criteria established through pairwise comparisons.

9. The system of claim 1, wherein the control effectiveness metric is selected from the group consisting of a change in Mean Time to Detect (MTTD), a change in Mean Time to Respond (MTTR), and a percentage reduction in successful phishing attempts.

10. The system of claim 1, further comprising an output module configured to transmit the prioritized list of cybersecurity controls in a machine-readable format to a Security Orchestration, Automation, and Response (SOAR) platform for automated implementation.

11. A computer-implemented method for dynamic and adaptive prioritization of cybersecurity controls, the method comprising:
(a) automatically processing, via a natural language processing (NLP) module executed by a processor, a plurality of unstructured threat reports to extract a structured threat object, the structured threat object comprising an adversary tactic, technique, or procedure (TTP) and an associated timestamp;
(b) computationally generating, by the processor, a time-decayed threat score for the extracted TTP by applying a mathematical decay function to an initial score based on an elapsed time calculated from the associated timestamp;
(c) predicting, via one or more machine learning (ML) models executed by the processor, at least one objective risk criterion associated with the TTP;
(d) generating, by the processor, a prioritized list of cybersecurity controls by computationally integrating the time-decayed threat score, the at least one predicted objective risk criterion, and a user-defined asset criticality value within a multi-criteria decision analysis (MCDA) model; and
(e) creating a self-optimizing closed-loop process by:
(i) receiving, at the processor, a control effectiveness metric from an operational environment, said metric computationally quantifying a measured performance change resulting from a previously implemented cybersecurity control, and
(ii) automatically using, by the processor, said control effectiveness metric as a new ground-truth training label to retrain the one or more ML models of step (c), thereby adaptively improving a predictive accuracy of future prioritizations generated by the processor over time.

12. The method of claim 11, wherein the NLP module comprises a transformer-based large language model fine-tuned on a corpus of cybersecurity-related text.

13. The method of claim 11, wherein the mathematical decay function includes a decay constant that is computationally determined based on a type of the extracted TTP.

14. The method of claim 11, wherein the at least one objective risk criterion is selected from the group consisting of a likelihood of exploitation, a predicted impact magnitude, and a predicted control effectiveness score.

15. The method of claim 11, wherein the MCDA model is an Analytic Hierarchy Process (AHP) model that provides an explainable and auditable basis for the prioritization.

16. The method of claim 11, wherein the control effectiveness metric is selected from the group consisting of a change in Mean Time to Detect (MTTD), a change in Mean Time to Respond (MTTR), and a percentage reduction in successful phishing attempts.

17. The method of claim 11, further comprising transmitting the prioritized list of cybersecurity controls in a machine-readable format to a Security Orchestration, Automation, and Response (SOAR) platform.
